(19) United States
(12) Patent Application Publication
(10) Pub. No.: US 2026/0034534 A1
(43) Pub. Date: Feb. 5, 2026

(54) COMPOSITE PARTICLES AND THEIR USE IN THE SELECTIVE CAPTURE AND RELEASE OF CARBON DIOXIDE WITH USE OF DIELECTRIC HEATING

(71) Applicant: UT-Battelle, LLC, Oak Ridge, TN (US)

(72) Inventors: Michelle K. Kidder, Clinton, TN (US); Aidan Klemm, Knoxville, TN (US)

(21) Appl. No.: 19/287,907

(22) Filed: Aug. 1, 2025

Related U.S. Application Data
(60) Provisional application No. 63/678,773, filed on Aug. 2, 2024.

(51) Int. Cl. B01J 20/32; B01D 53/14; B01J 20/02; B01J 20/10; B01J 20/22; B01J 20/28; B01J 20/34

(52) U.S. Cl. CPC B01J 20/3293; B01D 53/14; B01J 20/0229; B01J 20/103; B01J 20/22; B01J 20/28009; B01J 20/3206; B01J 20/3234; B01J 20/3441; B01D 2257/504; B01J 2220/58

(57) ABSTRACT

A carbon capture composite particle comprising a core and a shell, wherein: (i) the core of the carbon capture composite particle comprises a liquid sorbent reactive with carbon dioxide; and (ii) the shell of the carbon capture composite particle encapsulates said core and comprises a multiplicity of hydrophobic-coated oxide particles, wherein gas-permeable spacings are present between the hydrophobic-coated oxide particles, and said hydrophobic-coated oxide particles have a main group or transition metal oxide inner portion encapsulated by a coating of hydrophobic molecules. Also described herein is a method for capturing carbon dioxide by contacting a gaseous source containing CO₂ with the above-described carbon capture particles. Also described herein is an apparatus with a microwave-transparent or radiofrequency-transparent column (or window in the column) for regenerating carbon capture particles that have been reacted with CO₂ by exposing the particles to microwave or radiofrequency electromagnetic radiation for direct conductive heating.

### CROSS-REFERENCE TO RELATED APPLICATIONS

The present application claims benefit of U.S. Provisional Application No. 63/678,773 filed Aug. 2, 2024, all of the contents of which are incorporated herein by reference.

### STATEMENT REGARDING FEDERALLY SPONSORED RESEARCH

This invention was made with government support under Prime Contract No. DE-AC05-00OR22725 awarded by the U.S. Department of Energy. The government has certain rights in the invention.

### FIELD OF THE INVENTION

The present invention generally relates to carbon capture materials and their use in capturing carbon dioxide. The present invention more particularly relates to core-shell type particles and their use in capturing carbon dioxide, particularly where the core contains a liquid sorbent reactive with carbon dioxide and the shell contains hydrophobic-coated metal oxide particles.

### BACKGROUND

Post-industrial revolution anthropogenic activities have led to a rapid rise in greenhouse gases, particularly carbon dioxide (CO₂). Direct air capture (DAC) and point source capture of CO₂ are increasingly being used as part of an effort to restore the atmospheric CO₂ concentration to an optimal level while mitigating climate change. Despite the technological maturity of the CO₂ absorption process, it is still far off from worldwide commercial deployment mainly due to the energy intensive nature of the solvent regeneration step, which is known to consume up to 70% of the total operating cost.

The high regeneration energy of amine-based solvents, such as monoethanolamine (MEA), stems from the stable nature of the carbamate and bicarbonate ions formed during CO₂ absorption. Although conductive heating systems are well-matured for large scale implementation, conventional solvent regeneration by conductive heating is often inefficient, especially for traditional aqueous solvents (e.g., 30 wt % monoethanolamine (MEA)), due to non-uniform heating and overheating, which also leads to solvent degradation. In general, CO₂ desorption from aqueous solvents occurs with diluent evaporation, resulting in a high energy penalty. Thus, there would be a significant benefit in a method that could regenerate liquid CO₂ sorbents in a more energy efficient manner.

### SUMMARY

In one aspect, the present disclosure is directed to carbon capture (core-shell) composite particles that are highly efficient in capturing carbon dioxide, cost-efficient, non-volatile, environmentally friendly, easily integrated into large-scale operations, and easily regenerated by exposure to microwave or radiofrequency radiation, which results in dielectric heating of the composite particles. The core-shell particles described herein can also perform better than their native liquid form under dry or humid conditions. The core-shell particles described herein contain, at minimum, a core of a liquid sorbent reactive with carbon dioxide and a shell of hydrophobic-coated oxide particles surrounding the core.

In more particular embodiments, the carbon capture composite particles contain a core and a shell, wherein: (i) the core of the carbon capture composite particle comprises a liquid sorbent reactive with carbon dioxide; and (ii) the shell of the carbon capture composite particle encapsulates the core and comprises a multiplicity of hydrophobic-coated oxide particles, wherein the shell is gas-permeable, typically by having gas-permeable spacings present between the hydrophobic-coated oxide particles. The hydrophobic-coated oxide particles are themselves (individually) porous or non-porous. The hydrophobic-coated oxide particles have a main group or transition metal oxide inner portion encapsulated by a coating of hydrophobic molecules or functional groups. The hydrophobic molecules or functional groups may be, for example, linear or branched alkyl groups, typically containing at least or more than 4, 5, or 6 carbon atoms. In some embodiments, the carbon capture composite particle further includes magnetic nanoparticles (e.g., paramagnetic, superparamagnetic, or more particularly, iron-containing) embedded in the core or shell of the carbon capture particle. In some embodiments, the liquid sorbent is an ionic liquid, such as 1-ethyl-3-methylimidazolium 2-cyanopyrrolide. The liquid sorbent may alternatively be a deep eutectic solvent or alkylamine solvent. In further or separate embodiments, the oxide particles are silica particles.

In another aspect, the present disclosure is directed to a method for capturing carbon dioxide. The method includes contacting a gaseous source containing CO₂ with a carbon capture composite particle composition as described above, i.e., comprising a core and a shell (encapsulating the core) and optionally magnetic nanoparticles, to result in capture of CO₂ from the gaseous source in the carbon capture composite particle. Notably, the shell containing the hydrophobic-coated oxide particles is gas-permeable, typically by containing gas-permeable spacings present between the hydrophobic-coated oxide particles to permit passage of the gaseous source to the liquid sorbent in the core. The hydrophobicity of the oxide particles functions to reject water from the CO₂-containing gas stream making contact with the carbon capture particles. In further embodiments, the method further includes regenerating the liquid sorbent in the liquid-CO₂ (sorbent-CO₂) complex by exposing the liquid-CO₂ complex to a dielectric energy source, such as microwave or radiofrequency radiation. In some embodiments, the regenerated liquid sorbent is re-used to capture CO₂ and form a complex therewith.

In yet another aspect, the present disclosure is directed to an apparatus for regenerating a sorbent liquid in a sorbent-CO₂ complex. The apparatus includes at least the following components: (i) a column for housing the sorbent-CO₂ complex and through which a gas can flow, wherein the column includes or is at least partly constructed of a microwave-transparent or radiofrequency-transparent material through which microwave or radiofrequency radiation can be transmitted to the sorbent-CO₂ complex without heating the transparent column material; and (ii) a device for generating the microwave or radiofrequency radiation. In some embodiments, the column is partly or entirely constructed of a microwave-transparent or radiofrequency-transparent material (e.g., PTFE) and the column at least partly houses a cavity that produces the microwave or radiofrequency radiation. The custom designed microwave (MW) or radiofrequency (RF) reactor cell has been specially crafted for regenerating the sorbent materials on a continuous basis.

The technologies described herein provide a non-volatile hybrid powder that is synthetically cost effective and easy to mass produce. The composite powder is stabilized by functionalized silica particles rendering them hydrophobic to maximize surface area of contact between the gas and liquid sorbent without a continuous barrier, unlike that which is characteristic of other encapsulation methods. The design incorporates a reactive liquid, such as, for example, a reactive ionic liquid that is environmentally green, as a non-volatile solvent with high capture efficiency and ability to regenerate with energy efficient non-conductive heat through electromagenetic energy, such as microwave technology. The ionic liquid 1-ethyl-3-methylimidazolium 2-cyanopyrrolide, in particular, quickly responds to microwave radiation and is thus particularly suited as a microwave active solvent. Numerous other types of reactive solvents, as further discussed below, are microwave- and/or radiofrequency-active solvents, and thus, also suitable as a liquid sorbent for purposes of the present invention.

By virtue of the encapsulation of the solvent (e.g., reactive liquid) with hydrophobic oxide particles, the core-shell composite material is easy to handle for large applications, and responds well to selective sorption of CO₂. Moreover, the hydrophobic oxide encapsulation is advantageously inert and does not alter the chemical function of the reactive liquid, such as a reactive ionic liquid.

The approach described herein uses hydrophobic oxide nanoparticles to encapsulate droplets of reactive liquids (e.g., ionic liquids (rILs)), with the oxide particles functioning as surfactants, which may be likened to an inverted configuration. This leaves gaps for the permeation of gaseous CO₂ to travel through, thus effectively eliminating the need for diffusion through a continuous shell barrier to achieve CO₂ transport. The term “reactive,” as used herein, refers to the ability to form a bond with CO₂ to make carbamates, bicarbonates, carbonates, or other complexes with CO₂.

In an exemplary embodiment, silica nanoparticles are functionalized with octyl groups to form octylated silica (C₈SiO₂), and subsequently combined with the rIL, such as for example, 1-ethyl-3-methylimidazolium 2-cyanopyrrolide, by, for example, simple grinding with a mortar and pestle, to achieve up to 60 wt % rIL loading. The fabrication method is easy, uses cost-effective materials, and is excellent for liquids with negligible vapor pressure like rILs. Crosslinking between the silica particles from the functionalization process can lead to macrostructures up to 150 um in diameter filled with rIL. In other embodiments, the silica nanoparticles are alkyl-, alkyl-perfluorinated, or alkyl amine-tethered silica.

The carbon capacity and sorption kinetics can be enhanced with microwave-active sorbent materials having low volatility, since such sorbents can be regenerated efficiently and cost effectively with little energy (e.g., microwave or radiowave) compared to conventional thermal conductive heating. Moreover, microwave enhanced desorption and CO₂ regeneration can be practiced with renewable energy, thus making electromagnetic induced regeneration attractive for meeting the goals of direct air capture costs below $100/ton CO₂. The carbon capture material described herein is advantageously non-toxic, easily manufactured and not interrupted by supply chain issues, and has multiple integrated pathways, such as placement in a fluidized fixed bed or HVAC system to pass ambient air through without pressure drop or added energy requirements.

The present invention makes use of low cost, recyclable powdered sorbent materials that can easily scale and perform better than their native liquid form. The sorbent materials are effective carbon capture agents under dry or humid conditions and can be regenerated by microwave irradiation. The sorbent materials can include magnetic nanoparticles (such as iron oxide paramagnetic nanoparticles) to further enhance their efficiency through more localized heating. In some embodiments, to increase the rate of regeneration, the sorbent materials include iron oxide particles that are coated with any of various chemical functionalities (e.g., hydrophobic or hydrophilic) in order to tune the magnetic susceptibility to quickly enhance heat transfer in the hybrid powder. The magnetic particles may alternatively be uncoated. In some embodiments, uncoated magnetic particles are functionalized with hydroxy groups.

The hybrid powder-encapsulated solvent overcomes carbon capture challenges by providing a solution for easy handling of a non-toxic solid that is non-volatile and stable and can be regenerated using renewable energy. The powder shows high capture efficiency and kinetics for selective carbon dioxide capture, where the powdered coating provides a hydrophobic and brush-like geometry to repel water and polar volatiles found in air and flue gas emissions. The ionic liquid solvent is readily activated by electromagnetic energy, such as microwave, which has a lower energy requirement than thermal heat use since heat is generated through a non-conductive method (i.e., the container itself is not heated in addition to the solvent). The electromagnetic approach thus allows for cost efficient use of renewable energy resources while also reducing the degradation of materials.

Currently, most liquid sorbents for carbon capture are volatile (can release into the atmosphere or degrade easily), have mass transfer limitations, and are not easily regenerable or applicable to process integration at scale. These problems have herein been solved by use of a low volatile ionic liquid which is physically ground into a hydrophobic silica or other oxide particles, which overcomes mass transfer limitations and results in higher kinetics of sorption and reaches higher carbon capture capacity efficiently. The hybrid silica-ionic liquid composite advantageously does not require expensive solvents or materials and is easily handled as a resulting powder. The powder is hydrophobic and overcomes the sorption of water, which thus avoids the energy penalty during the regeneration due to bicarbonate formation. The sorbent materials described herein are MW or RF active, and thus, electromagnetic energy can be used in place of fossil-derived thermal energy and provides the benefit of directly heating the sample, as opposed to heating the containment chambers by thermal conductive heating. The process described herein provides substantially more control over direct heating and less exposure time to the heating and cooling of the sample, which thus results in less energy input from direct MW or RF heating. Finally, the direct heating of the polar sorbent results in less heating time experienced using MW or RF, which results in less degradation from oxidative or thermal decomposition compared to thermal conductive heating. These samples can be integrated into fluidized beds, HVAC filters, and the like, and can easily overcome pressure drop issues. They also have the ability to be put into geometric forms as pellets or additively manufactured for large scale applications. The materials are also easily accessible and are less susceptible to supply chain manufacturing issues.

### BRIEF DESCRIPTION OF THE DRAWINGS

FIG. 1. Schematic representation of a method for preparing carbon capture composite (CCC) particles having a core-shell arrangement.

FIG. 2. Schematic of a custom apparatus for breakthrough analysis with microwave (MW) regeneration. Sample column is expanded.

### DETAILED DESCRIPTION

In a first aspect, the present disclosure is directed to a carbon capture composite (CCC) particle (or “carbon capture particle”) composition. The CCC particle has a core-shell composition in which the core portion of the CCC particle is encapsulated by the shell portion. The CCC particles generally have a size within a range of 0.01-1,000 microns. In more particular embodiments, the CCC particles have a size in a range of 0.01-500 microns, 0.01-250 microns, 0.01-100 microns, 0.01-50 microns, 0.01-10 microns, 0.1-500 microns, 0.1-250 microns, 0.1-100 microns, 0.1-50 microns, 0.1-10 microns, 1-1000 microns, 1-500 microns, 1-250 microns, 1-100 microns, 1-50 microns, 1-10 microns, 10-1000 microns, 10-500 microns, 10-250 microns, 10-100 microns, or 10-50 microns.

The core of the carbon capture particle contains a liquid sorbent reactive with carbon dioxide. By being “reactive” with carbon dioxide, the liquid sorbent binds with carbon dioxide to form a carbamate, bicarbonate, or carbonate salt. The liquid sorbent typically includes a primary amine, secondary amine, tertiary amine (or hindered amine), aryl amine, and/or an imide group to be reactive with carbon dioxide. The liquid sorbent may be, for example, an ionic liquid, a deep eutectic solvent, or alkylamine solvent.

In a first set of embodiments, the liquid sorbent in the core is or includes an ionic liquid that is reactive with carbon dioxide. As well known in the art, the term “ionic liquid” refers to an ionic compound (i.e., compound containing a cation associated with an anion) that is liquid at or around room temperature without being dissolved in a liquid solvent. In some embodiments, the ionic liquid contains an imidazolium, ammonium, piperidinium, piperazinium, pyridinium, pyrrolidinium, phosphonium, or sulfonium cationic portion. In separate or further embodiments, the ionic liquid includes a N-heterocyclic (e.g., cyanopyrrolide), amino acid, tetrafluoroborate, hexafluorophosphate, or sulfonylimide (e.g., Tf₂N) type of anion. Ionic liquids containing any combination of cation and anion provided above are considered herein. Some examples of ionic liquids that can function as carbon capture sorbents include the class of 1,3-dialkylimidazolium 2-cyanopyrrolides (e.g., 1-ethyl-3-methylimidazolium 2-cyanopyrrolide), the class of choline amino acid ionic liquids (e.g., choline prolinate), the class of 1,3-dialkylimidazolium boron tetrafluorides (e.g., 1-butyl-3-methylimidazolium boron tetrafluoride), and the class of 1,3-dialkylimidazolium phosphorus tetrafluorides (e.g., 1-butyl-3-methylimidazolium phosphorus tetrafluoride), wherein the term “alkyl” is independently, in each instance, selected from linear or branched alkyl groups containing 1-12 carbon atoms (or more particularly, 1-6, 1-4, or 1-3 carbon atoms). A range of possible carbon-capturing ionic liquids are described in W. F. Elmobarak et al., Fuel, 344, July 2023, 128102, the contents of which are herein incorporated by reference. Any such ionic liquid may be included in the core of the carbon capture particle described herein.

In a second set of embodiments, the liquid sorbent in the core is or includes a deep eutectic solvent (DES), which are well known in the art. For purposes of the present invention, the DES should have the ability to be reactive with carbon dioxide. As well known, a DES is a liquid formed from two precursors which, when complexed with each other, form a substance having a substantially lower melting point than the precursors. The DES may be a Type I, Type II, or Type III DES solvent. A range of possible DES solvents with carbon capture ability are described in J. Ruan et al., Green Chem., 25, 8328-8348, 2023, the contents of which are herein incorporated by reference. In some embodiments, the DES is a glycerol-based deep eutectic solvent, such as described in M. K. AlOmar et al., Journal of Molecular Liquids, 215, 98-103, March 2016, the contents of which are herein incorporated by reference. The glycerol-based DES may be composed of, for example, glycerol combined with an ammonium or phosphonium salt. Alternatively, the DES may contain monoethanolamine, diethanolamine, ethylene diamine, diethylenetriamine, triethylenetetramine, tetraethylenepentamine, ethylene glycol, propylene glycol, diethylene glycol, triethylene glycol, and/or tetraethylene glycol in combination with an ammonium or phosphonium salt, wherein urea may or may not be included as an additional component. In some embodiments, the salt component of the DES can be or include any of the aforementioned ionic liquids. Some particular examples of DES solvents include choline chloride-monoethanolamine, glyceline, reline, piperazine glyceline, tetraethylenepentamine chloride-thymol, choline chloride-ethanolamine-urea, methyltriphenylphosphonium bromide-ethylene glycol, methyltriphenylphosphonium bromide-glycerol, methyltriphenylphosphonium bromide-diethylene glycol, tetrapropylammonium chloride-ethanolamine, 1-ethyl-3-methylimidazolium 2-cyanopyrrolide-ethylene glycol, and choline prolinate ethylene glycol.

In a third set of embodiments, the liquid sorbent in the core is or includes an alkylamine solvent. The alkylamine may, in some embodiments, be a hydrophobic amine that can dissolve in an organic (non-aqueous) solvent (NAS) or low-aqueous solvent (LAS). In other embodiments, the alkylamine can dissolve in an aqueous solution. The alkylamine typically has the formula NR^{d}R^{e}R^{f}, wherein R^{d}, R^{e}, and R^{f} are selected from H and hydrocarbon groups containing one or more carbon atoms, wherein one, two, or all three of Rd, Re, and Rf are selected from hydrocarbon groups. The hydrocarbon groups may independently contain 1, 2, 3, 4, 5, 6, 7, 8, 9, 10, 11, or 12 carbon atoms and may or may not contain one or more heteroatoms selected from O, N, and S. In different embodiments, the hydrocarbon groups contain 1-12, 1-6, 1-4, 1-3, 2-12, 2-6, 2-4, or 2-3 carbon atoms. The hydrocarbon groups may be linear or branched alkyl or alkenyl groups or saturated or unsaturated monocyclic or bicyclic groups. Some examples of hydrocarbon groups include methyl, ethyl, n-propyl, isopropyl, n-butyl, isobutyl, n-pentyl, n-hexyl, isohexyl, n-octyl, 2-ethylhexyl, 2-ethyloctyl, n-decyl, n-dodecyl, cyclohexyl, phenyl, pyridyl, and tolyl groups. Some examples of such alkylamines include triethylenetetramine, polyethyleneimine, tetraethylenepentamine, diethylenetriamine, trimethylpropane-1,3-diamine, N-(2-ethoxyethyl)-N,N-diisopropylethane-1,2-diamine, N-(2-ethoxyethyl-3-morpholinopropan-1-amine, and N-isobutyl-3-morpholinopropan-1-amine.

The term “alkylamine,” as used herein, may also include alkanolamines. Alkanolamines are well known in the art for carbon dioxide capture. Some examples of alkanolamines include monoethanolamine (MEA), diethanolamine (DEA), triethanolamine (TEA), diglycolamine (DGA), methyldiethanolamine (MDEA), diisopropanolamine, 2-amino-2-methyl-1-propanol, 2-(piperidin-2-yl)ethanol, 2-(diethylamino)ethanol (DEEA), N-butyldiethanolamine (BDEA), N-t-butyldiethanolamine (t-BDEA), and N-ethyldiethanolamine (EDEA).

The shell of the carbon capture composite particle encapsulates (surrounds) the core and contains a multiplicity of hydrophobic-coated oxide particles (HCOPs), wherein gas-permeable spacings (pores or gaps) are present between the HCOPs. The HCOPs generally have a size within a range of 1-1000 nm. In more particular embodiments, the HCOPs have a size in a range of 1-500 nm, 1-250 nm, 1-100 nm, 1-50 nm, 1-20 nm, 1-10 nm, 5-1000 nm, 5-500 nm, 5-250 nm, 5-100 nm, 5-50 nm, 5-20 nm, 5-10 nm, 10-1000 nm, 10-500 nm, 10-250 nm, 10-100 nm, 10-50 nm, 10-20 nm, 50-1000 nm, 50-500 nm, 50-250 nm, or 50-100 nm. As the HCOPs occupy only a portion of the total volume of the carbon capture composite particle, the carbon capture composite particle is necessarily larger than the HCOPs, e.g., 0.01-1000 microns (or, more particularly, 0.01-100 microns, 0.01-50 microns, 0.1-1000 microns, 0.1-100 microns, 0.1-50 microns, 1-1000 microns, 1-500 microns, 1-100 microns, or 1-50 microns). The spacings between HCOPs typically have a minimum size of 0.1, 0.2, 0.5, or 1 nm and a maximum size 2, 5, 10, 50, 100, 200, 500, or 1000 nm, or spacings in a range bounded by any two of these values, e.g., 0.1-1000 nm, 0.1-500 nm, 0.1-200 nm, 0.1-100 nm, 0.1-10 nm, 0.1-1 nm, or 0.1-0.5 nm. The HCOPs are present in an amount of precisely or about 30 wt %, 35 wt %, 40 wt %, 45 wt %, 50 wt %, 55 wt %, 60 wt %, 65 wt %, 70 wt %, 75 wt %, 80 wt %, 85 wt %, or 90 wt % by weight of the carbon capture particle. The HCOPs may alternatively be present in an amount within a range bounded by any two of the foregoing values, e.g., 30-90 wt %, 40-80 wt %, or 50-70 wt % of the carbon capture particle.

The HCOPs have a main group or transition metal oxide inner portion encapsulated by a coating of hydrophobic molecules. The main group metal may be any of the elements in Groups 13-15 of the Periodic Table. The transition metal may be any of the elements in Groups 3-12 of the Periodic Table and may be a first row, second row, or third row transition metal. The metal oxide may or may not include hydroxide (OH) groups. Some examples of main group oxide compositions for the inner of the HCOPs include SiO₂ (i.e., silica, e.g., glass or ceramic), B₂O₃, Al₂O₃ (alumina), Ga₂O₃, SnO, SnO₂, PbO, PbO₂, Sb₂O₃, Sb₂O₅, and Bi₂O₃. Some examples of transition metal oxide compositions include Sc₂O₃, TiO₂ (titania), TiO(OH)₂, MoO₃, V₂O₅, Cr₂O₃, Fe₂O₃, Fe₃O₄, FeO, FeO(OH), CO₂O₃, Ni₂O₃, NiO, CuO, Cu₂O, MnO₂, ZnO, Y₂O₃ (yttria), ZrO₂ (zirconia), NbO₂, Nb₂O₅, RuO₂, PdO, Ag₂O, CdO, HfO₂, Ta₂O₅, WO₃, WO₂, Ag₂O, and PtO₂, or a mixed oxide composition containing any two or more of the above. In some embodiments, any one or more of the foregoing species of oxide composition are excluded from the shell. In some embodiments, the shell may include or exclusively contain hydrophobized particles having a magnetic oxide composition (e.g., Fe₂O₃, Fe₃O₄, or FeO), in which case the shell of hydrophobized magnetic oxide particles can serve as the HCOP and magnetic particles, thereby not requiring the presence of other magnetic particles. In some embodiments, the shell is composed of magnetic oxide particles in admixture with non-magnetic oxide particles, such as silicon dioxide. In some embodiments, the oxide in the HCOP is non-magnetic or does not contain iron. In particular embodiments, the oxide in the inner portion of the HCOP is or includes silica (SiO₂). In other particular embodiments, the oxide in the inner portion of the HCOP is or includes a silicate or an aluminosilicate (i.e., zeolites or clays). The zeolite may be an H-type zeolite or metal ion-exchanged zeolite. Some examples of zeolites include HZSM-5, H-Y, H-Beta, SAPO-34, and SSZ-13 types of zeolites. Notably, the oxide inner portion may or may not include elements other than main group or transition metal elements, e.g., alkaline earth and/or lanthanide elements.

Any of the oxide inner portions exemplified above are encapsulated by a coating of hydrophobic molecules to result in HCOPs that encapsulate the liquid sorbent core of the carbon capture particles. In typical embodiments, HCOPs are produced by reacting an oxide particle (e.g., silica or titania particles) with trialkoxyalkylsilane (e.g., trimethoxy or triethoxyoctylsilane, i.e., TEOS) molecules in the presence of a base or acid to induce covalent bonding of the trialkoxyalkylsilane to the surface of the oxide particle. Oxide particles may alternatively be reacted with an alkylphosphonic acid (e.g., hexylphosphonic acid) or alkylcarboxylic acid (e.g., docosanoic acid) to bond alkyl groups to the surface of the oxide particles to result in HCOPs. The resulting coated oxide particles are thus alkyl-coated oxide particles.

In some embodiments, the carbon capture composite particle further includes magnetic nanoparticles embedded in the core and/or shell of the carbon capture particle. The individual magnetic particles are typically ferromagnetic or ferrimagnetic, leading to bulk paramagnetism or superparamagnetism. More typically, the magnetic particles have an iron-containing composition, such as an Fe₃O₄ (magnetite) composition. Other magnetic compositions include Fe₂O₃ (maghemite), Fe, Co, Nd, NdFeB, or any other ferromagnetic or ferrimagnetic material. The magnetic nanoparticles generally have a size within a range of 1-500 nm. In more particular embodiments, the magnetic nanoparticles have a size in a range of 1-250 nm, 1-100 nm, 1-50 nm, 1-20 nm, 1-10 nm, 5-500 nm, 5-250 nm, 5-100 nm, 5-50 nm, 5-20 nm, 5-10 nm, 10-500 nm, 10-250 nm, 10-100 nm, 10-50 nm, 10-20 nm, 50-500 nm, 50-250 nm, or 50-100 nm. The magnetic particles can be uncoated (typically, native OH-functionalized) or hydrophobized (e.g., oleic acid coated) magnetic particles.

The carbon capture core-shell particles described above can be produced by any method in which a liquid sorbent can be integrally mixed with hydrophobic oxide particles and optionally magnetic particles until a visually uniform homogeneous and free-flowing powder is formed. In typical embodiments, the carbon capture core-shell particles are produced by grinding (either manually or by machine) a liquid sorbent and hydrophobic oxide particles until a visually uniform homogeneous and free-flowing powder is formed. This may also be achieved using a blender or an emulsifier to combine the components.

In another aspect, the present disclosure is directed to a method for capturing carbon dioxide by use of any of the carbon capture composite (CCC) particles described above. In the method, the CCC particles are contacted with a gaseous source containing carbon dioxide. The gaseous source can be, for example, air, waste gas from an industrial or commercial process, flue gas from a power plant, exhaust from an engine, or sewage or landfill gas, any of which may be raw or cleansed upon contact with the carbon capture particles. The gas-permeable spacings in the shell of the CCC particles permit passage of the gaseous source to the liquid sorbent in the core. Upon contact, the gaseous source infiltrates into the gas-permeable spacings in the shell of the CCC particles and migrates through the shell to make contact with the liquid sorbent in the core of the CCC particles.

The liquid sorbent, such as any of those described above, typically reacts with carbon dioxide to form a carbamate or an ion pair bond of the formula:

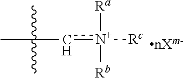

wherein R^{a}, R^{b}, and R^{x} are selected from H and hydrocarbon groups as described above, e.g., containing 1-12 carbon atoms (e.g., methyl and any of the other hydrocarbon groups described above), wherein at least one of R^{a}, R^{b}, and R^{c} is H; the dashed double bond represents the presence or absence of a double bond (i.e., if the dashed double bond is absent, the single bond to R^{c} remains), and the dashed single bond represents the presence or absence of R^{c}, wherein R^{c} is present only if the double bond is not present (or conversely, R^{c} is absent if the double bond is present); X^{m-} is a carbonate (CO₃²⁻) or bicarbonate (HCO₃⁻) anion, with m being 1 for bicarbonate and 2 for carbonate; and n is an integer of 1 or 2, provided that n×m=2.

More specifically, the ion pair bond has any of the following two formulas:

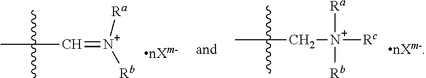

The method may further include a step of regenerating the carbon capture particles after they form a complex with carbon dioxide. In the method for regenerating a carbon dioxide sorbent material, carbon capture particles containing a sorbent-CO₂ complex containing CO₂ in the form of a carbamate, bicarbonate, or carbonate, as described above, are exposed to microwave (MW) or radiofrequency (RF) radiation. Upon exposure to the radiation, the sorbent-CO₂ complex reverts to the original active sorbent along with release of carbon dioxide, wherein the released carbon dioxide may be pressurized and stored for later use in a carbon dioxide conversion process (to produce a valuable commodity chemical), oil enhanced recovery, or a dry ice manufacturing process. Typically, the regeneration process does not expose the carbon capture complexed particles to direct heating. Although the MW or RF radiation may produce some amount of residual heat, the primary mechanism by which the MW or RF radiation induces regeneration is by electromagnetic-induced rearrangement of the molecular bonds in the liquid-CO₂ complex. In some embodiments, the regenerated capture carbon particles are re-used to capture CO₂ and form a complex therewith. The re-used carbon capture particles may then be regenerated, and the cycle continued.

In another aspect, the present disclosure is directed to an apparatus for regenerating a sorbent liquid in a sorbent-CO₂ complex as described above. The apparatus includes the following components: (i) a column for housing the sorbent-CO₂ complex and through which a gas can flow, wherein the column is partially or completely microwave-transparent or radiofrequency-transparent to permit microwave or radiofrequency radiation to be transmitted through the column to contact the sorbent-CO₂ complex and (ii) a device for generating MW or RF radiation. In some embodiments, the column is entirely MW-transparent or RF-transparent. In some embodiments, the MW-transparent or RF-transparent window or column is constructed of poly(tetrafluoroethylene) (PTFE). In some embodiments, the column includes a MW-transparent or RF-transparent window through which MW or RF radiation can be transmitted to contact the sorbent-CO₂ complex. Typically, the column is within an enclosed chamber in which MW or RF is generated. The enclosed chamber may be, for example, a MW or RF cavity. The apparatus is also typically fitted with an inlet and outlet for purging of gases in the column. The top and bottom of the column typically contains glass frits which allow for packing of the material between the inlet and outlet while permitting the gas to pass through the frit to provide an even distribution of gas flow and preventing particles from being released at the outlet.

Examples have been set forth below for the purpose of illustration and to describe certain specific embodiments of the invention. However, the scope of this invention is not to be in any way limited by the examples set forth herein.

### EXAMPLES

### Overview

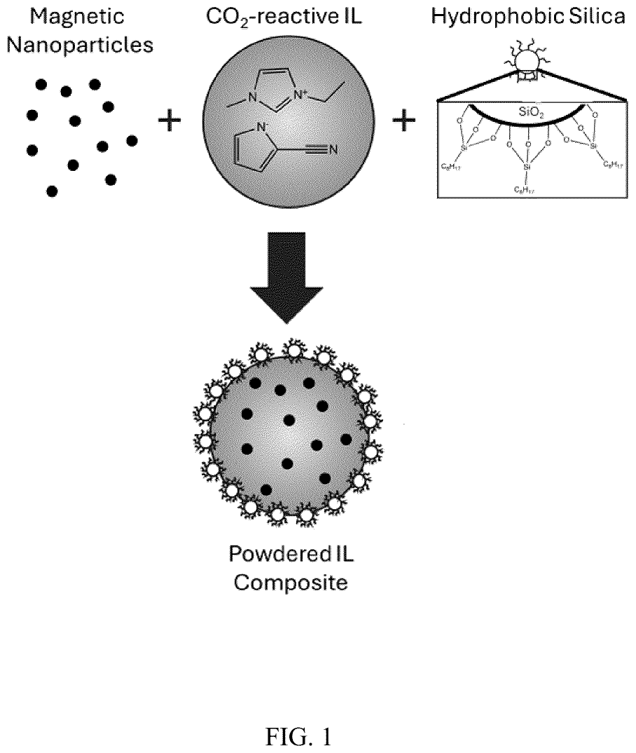

In the following experiments, carbon capture particles were prepared by a method shown schematically in FIG. 1. Although an ionic liquid (specifically, 1-ethyl-3-methylimidazolium 2-cyanopyrrolide) is depicted as the CO₂-reactive sorbent, any of the reactive ionic liquids, deep eutectic solvents, or alkylamines described above can be instead used. Moreover, although hydrophobic silica particles are depicted, any of the hydrophobic oxide particles described above (e.g., titania or zirconia) can instead be used.

### Experimental Methods

Functionalized Silica Support-C₈SiO₂

10 g of SiO₂, Cabosil® M-5 (1.5 mmol OH/g) particles (5-50 nm; agglomerated >100 nm) surface area of 200 m²/g, was suspended in a solution of 200 mL of EtOH, 11 mL NH₃(aq), and triethoxy (octyl) silane (C₈TEOS) at 0.3 mol equivalent to OH on the silica. The suspension was stirred overnight at room temperature, after which the liquid was removed via drying on a hotplate at 50° C. The resulting solid was ground via mortar and pestle to break up large clumps and then dried under vacuum at 50° C. overnight.

### Ionic Liquid [EMIM][2CNpyr] Synthesis

[EMIM][2CNpyr] was synthesized by exchanging [EMIM][Br] to [EMIM][OH] with an anion exchange resin column followed by metathesis with H-2CNPyr. Here the column was prepared by adding 40 g of Amberlite® IRN-78 resin to a chromatography column, rinsing with 200 mL H₂O, and conditioning with 250 mL of 1 N NaOH. The column was allowed to drip slowly for 1 hr, followed by neutralizing it to pH of 7 with H₂O. A 50/50 H₂O/MeOH (v/v) was then flowed through the column followed by pure methanol (MeOH). 2 g of [EMIM] [Br] (10.4 mmol) was dissolved in a minimal amount of MeOH added to the column and eluted with MeOH slowly. Bromide removal was confirmed by a silver nitrate test. 1 g (10.8 mmol, 1.04× excess) of H-2CNPyr was added to the [EMIM][OH] MeOH solution and mixed. Solvent was removed by rotary evaporation followed by drying under vacuum at 50° C.

### Composites of Powdered Sorbents

Powdered liquids were fabricated through grinding the support, i.e., C₈SiO₂ with desired weight loading of sorbent (i.e., amine, ionic liquid or deep eutectic or polyethyleneimine, PEI) [EMIM][2CNPyr], with a mortar and pestle until a visually uniform, homogeneous free-flowing powder was formed (˜60 seconds).

For composites containing magnetic nanoparticles, the desired weight loading of magnetic nanoparticles (commercially obtained Fe₃O₄, Fe₃O₄-silane coated, Fe₃O₄—OH functionalized, and Fe₃O₄-oleic acid coated) was added to the sorbent (0-1 wt %) then this was ground with the C₈SiO₂ as above.

### Breakthrough Measurements and Regeneration

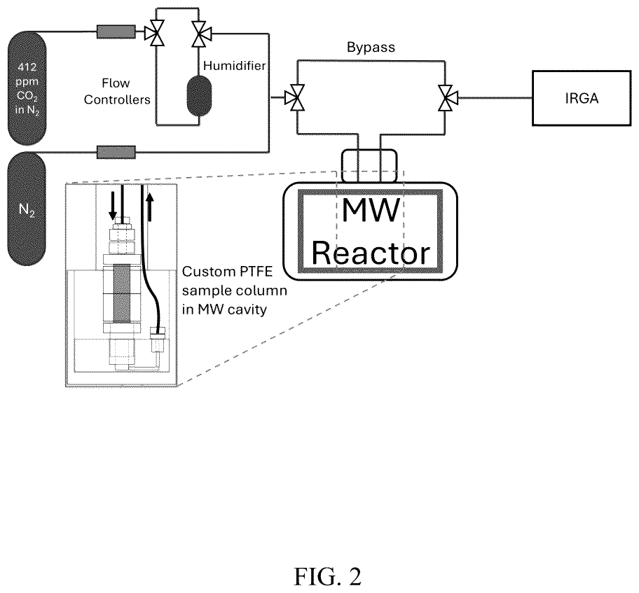

Breakthrough measurements with MW regeneration were performed using a custom build apparatus depicted in FIG. 2. Commercial flow controllers with a range of 0-1.2 L min-1 were used to control flow rate, and a commercial infrared gas analyzer (IRGA) was used to measure CO₂ concentration and flowrate. The composite materials were pretreated at 60° C. under vacuum for 1 hr and cooled under argon. 400 mg of sample was packed into the column and sealed on either end with a glass fiber filter. To maintain the integrity of the glass fiber filters, a glass frit was cut to size and used to support the filter. Pure N₂ was run through the column at room temperature to remove any remaining air, CO₂, and moisture during loading, until the measured CO₂ concentration was 0 ppm and regulated for a ˜200 mL min⁻¹ flow rate. The flow was then diverted to bypass and feed gas was switched to 412 ppm CO₂ in N₂. Upon stabilization at the expected concentration for 1 min, the flow was switched back to the column for absorption. The experiment was stopped by switching back to the bypass after CO₂ concentration returned to the feed concentration. To study humid conditions, the feed was bubbled through water in a stainless-steel humidifier following the flow controller. Under MW desorption conditions, the feed gas was switched to pure N₂ and sent to the column until stabilization at 0 ppm for 1 min. The MW (2.45 GHZ) was activated at the desired power for 1 hour.

Breakthrough varying humid conditions were measured with the same equipment and sample preparation. Using the MFCs to maintain a flowrate of 100 sccm, the CO₂ was fed through the cell containing water to create a humid stream, which was then mixed with a dry line of the same gas at the desired ratio to achieve the desired % RH. A steady pressure drop of 85 kPa was observed throughout the experiments. To prevent water condensation in the column due to pressure drop, 0%, 13%, 21%, and 35% RH were measured, corresponding to 0, 0.25, 0.5, and 0.75 contribution from the humid stream (1 00% RH @ 25° C.=31.6 mbar, 31.6/1.85=17.3 mbar or 55% RH @ 25° C.). The humidifier was also kept at room temperature (˜21° C.).

Capacity for CO₂ and H₂O were calculated via Equation 1:

$${z}_{i} = \frac{( {\int }_{0}^{t} F ( 1 - {C}_{i} / {C}_{i , 0} ) dt ) {C}_{i , 0}}{{\hat{V}}_{STP} \cdot W}$$

where zᵢ is the loading of component i in the sorbent, t is time in min, F represents the feed flow rate in sccm, Cᵢ and C_{i,0} are the concentrations of component i (in ppm) in the feed and exit streams, respectively, \hat{V}_{STP} is the molar volume of an ideal gas at STP (22.4 cm³/mmol), and W is the weight of the sample in grams. Breakthrough capacity was calculated by setting t to the breakthrough time, t_{BT}, when the effluent CO₂ concentration reached 5% of the feed concentration, and final capacity was calculated setting t to the final time, t_{f}, when the effluent CO₂ concentration reached 99% of the feed concentration.

While there have been shown and described what are at present considered the preferred embodiments of the invention, those skilled in the art may make various changes and modifications which remain within the scope of the invention defined by the appended claims.

What is claimed is:

1. A carbon capture composite particle composition comprising a core and a shell, wherein:
(i) the core of said carbon capture composite particle comprises a liquid sorbent reactive with carbon dioxide; and
(ii) the shell of said carbon capture composite particle encapsulates said core and comprises a multiplicity of hydrophobic-coated oxide particles, wherein gas-permeable spacings are present between the hydrophobic-coated oxide particles, and said hydrophobic-coated oxide particles have a main group or transition metal oxide inner portion encapsulated by a coating of hydrophobic molecules.

2. The composition of claim 1, wherein the carbon capture composite particle further comprises magnetic nanoparticles embedded in the core or shell of the carbon capture particle.

3. The composition of claim 1, wherein said liquid sorbent is an ionic liquid.

4. The composition of claim 3, wherein the ionic liquid sorbent is an imidazolium ionic liquid.

5. The composition of claim 4, wherein the imidazolium ionic liquid is 1-ethyl-3-methylimidazolium 2-cyanopyrrolide.

6. The composition of claim 1, wherein said liquid sorbent is a deep eutectic solvent.

7. The composition of claim 6, wherein the deep eutectic solvent is selected from the group consisting of choline chloride-monoethanolamine, glyceline, reline, piperazine glyceline, tetraethylenepentamine chloride-thymol, choline chloride-ethanolamine-urea, methyltriphenylphosphonium bromide-ethylene glycol, methyltriphenylphosphonium bromide-glycerol, methyltriphenylphosphonium bromide-diethylene glycol, and tetrapropylammonium chloride-ethanolamine.

8. The composition of claim 1, wherein said liquid sorbent is an alkylamine solvent.

9. The composition of claim 1, wherein said hydrophobic-coated oxide particles are hydrophobic-coated silica particles.

10. The composition of claim 1, wherein said hydrophobic-coated oxide particles are alkyl-coated oxide particles.

11. The composition of claim 1, wherein said spacings have a size in a range of 0.1-1000 nm.

12. The composition of claim 1, wherein said hydrophobic-coated oxide particles have a size in a range of 1-1000 nm.

13. The composition of claim 1, wherein the carbon capture (core-shell) composite particle has a size in a range of 0.01-1000 microns.

14. The composition of claim 2, wherein the magnetic particles are paramagnetic or superparamagnetic.

15. The composition of claim 14, wherein the paramagnetic or superparamagnetic particles have an iron-containing composition.

16. The composition of claim 1, wherein the hydrophobic-coated oxide particles are present in an amount of 30-90 wt % of the carbon capture particle.

17. A method for capturing carbon dioxide, the method comprising contacting a gaseous source containing CO₂ with a carbon capture composite particle composition comprising a core and a shell encapsulating the core to result in capture of CO₂ from the gaseous source in the carbon capture composite particle, wherein:
(i) the core of said carbon capture composite particle comprises a liquid sorbent reactive with CO₂ and forms a sorbent-CO₂ complex upon contact with CO₂; and
(ii) the shell of said carbon capture composite particle encapsulates said core and comprises a multiplicity of hydrophobic-coated oxide particles, wherein gas-permeable spacings are present between the hydrophobic-coated oxide particles to permit passage of the gaseous source to the liquid sorbent in the core, and said hydrophobic-coated oxide particles have a main group or transition metal oxide inner portion encapsulated by a coating of hydrophobic molecules.

18. The method of claim 17, wherein the carbon capture composite particle further comprises magnetic particles embedded in the core or shell of the carbon capture particle.

19. The method of claim 17, wherein said liquid sorbent is an ionic liquid.

20. The method of claim 17, wherein said liquid sorbent is a deep eutectic solvent.

21. The method of claim 17, wherein said liquid sorbent is an alkylamine solvent.

22. The method of claim 17, wherein said hydrophobic oxide particles are hydrophobic silica particles.

23. The method of claim 17, further comprising regenerating the liquid sorbent in the sorbent-CO₂ complex by exposing said sorbent-CO₂ complex to microwave or radiofrequency radiation.

24. The method of claim 23, wherein the regenerated liquid sorbent is re-used to capture CO₂ and form a complex therewith.

25. An apparatus for regenerating a sorbent liquid in a sorbent-CO₂ complex, the apparatus comprising:
(i) a column for housing the sorbent-CO₂ complex and through which a gas can flow, wherein said column is partially or completely microwave-transparent or radiofrequency-transparent to permit microwave or radiofrequency radiation to be transmitted through the column to contact the sorbent-CO₂ complex; and
(ii) a device for generating microwave or radiofrequency radiation.

26. The apparatus of claim 25, wherein the microwave-transparent or radiofrequency-transparent column has a polytetrafluoroethylene (PTFE) composition.
